(19) United States
(12) Patent Application Publication
(10) Pub. No.: US 2019/0212828 A1
(43) Pub. Date: Jul. 11, 2019

(54) OBJECT ENHANCEMENT IN ARTIFICIAL REALITY VIA A NEAR EYE DISPLAY INTERFACE

(71) Applicant: Facebook Technologies, LLC, Menlo Park, CA (US)

(72) Inventors: Kenrick Cheng-kuo Kin, Vancouver, WA (US); Albert Peter Hwang, Seattle, WA (US)

(21) Appl. No.: 15/867,641

(22) Filed: Jan. 10, 2018

(51) Int. Cl. G06F 3/01; G06T 19/20; G06T 19/00; G02B 27/01; G06F 3/0481

(52) U.S. Cl. CPC G06F 3/017; G06T 19/20; G06F 3/04815; G02B 27/017; G06F 3/011; G06T 19/006

(57) ABSTRACT

A system includes a near eye display (NED) that is configured to display images in accordance with display instructions. The system also includes an imaging sensor configured to capture images. The system further includes a controller configured to identify the object in the captured images using one or more recognition patterns, and to determine a pose of the user's hand based on the captured images, with the determined pose indicating a touch gesture with the identified object. The controller also updates the display instructions to cause the electronic display to display a virtual menu in an artificial reality environment, with the virtual menu within a threshold distance of the position of the object in the artificial reality environment.

### BACKGROUND

The present disclosure generally relates to object and eye tracking, and specifically to object enhancement in an artificial reality system.

Augmented reality systems typically rely on wearable devices that have smaller form factors than classical virtual reality (VR) head mounted devices. The use of augmented reality systems presents new challenges in user interaction. Previous methods of user interaction with the local area may not be sufficient or optimal in an augmented reality system. For example, without the use of augmented reality, a user may need to interact physically with a device in a local area in order to enable a change in that device. However, with the user of augmented reality, both the device and the user experience may be upgraded to allow the user to cause a change in the device using methods other than simply physical interaction. However, such changes in user experience should be intuitive for the user to understand and should be technically feasible. Current method of user interaction in augmented reality are not readily intuitive and do not exploit the technical capabilities of an augmented reality system, and thus are not optimal for use.

### SUMMARY

A near-eye display (NED) system provides graphical elements (e.g., an overlay) to augment physical objects as part of an artificial reality environment. The system includes a near eye display (NED), an imaging sensor, and a controller. The NED has an electronic display configured to display images in accordance with display instructions. The imaging sensor is configured to capture images of a local area. The images including at least one image of an object and at least one image of a user's hands. In some embodiments, the imaging sensor may be part of the NED. The controller is configured to identify the object in at least one of the images captured by the imaging sensor using one or more recognition patterns. The controller is configured to determine a pose of the user's hand using at least one of the images. The determined pose may indicate that, e.g., a touch gesture is being performed by the user with the identified object. The touch gesture may be formed by, e.g., a movement of the user's index finger in a direction towards the identified object such that the distance between the user's index finger and a position of the object is within a threshold value. The controller is configured to update the display instructions to cause the electronic display to display a virtual menu in an artificial reality environment, the virtual menu within a threshold distance of the position of the object in the artificial reality environment.

### BRIEF DESCRIPTION OF THE DRAWINGS

FIG. 1 is a diagram of an eyewear device, in accordance with an embodiment.

FIG. 2 is a cross section of the eyewear device of FIG. 1, in accordance with an embodiment.

FIG. 3 is a block diagram of a NED system with an eye tracker, in accordance with an embodiment.

FIG. 4A illustrates an exemplary NED display filter applied to an NED for enhancing a physical object with virtual elements, according to an embodiment.

FIG. 4B illustrates an exemplary NED display filter applied to the NED of FIG. 4A for providing a virtual menu upon interaction with an enhanced object, according to an embodiment.

FIG. 4C illustrates an exemplary NED display filter applied to the NED of FIG. 4B for providing a secondary virtual contextual menu upon interaction with a virtual menu of an enhanced object, according to an embodiment.

FIG. 5 is a flowchart illustrating a method for providing object enhancement in a NED, according to an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

Additionally, in some embodiments an eyewear device includes an eye tracking system. The eye tracking system includes one or more light sources and a camera. The eyewear device also includes an optical assembly, which may include an electronic display or display path element (such as a waveguide display), a lens or lens stack (such as a powered optical element, corrective lens, or a UV lens), or a combination of displays and/or lenses.

The eye tracking system may be used, in conjunction with a system to track one or more objects in the local area, in order to display additional information about the objects, such as other users, to the user via the eyewear device (e.g., via the optical element of the eyewear device). This information may include information received from an online system regarding other users in the local area. The system may additionally include a hand pose and gesture tracking system to allow the user of the eyewear device to select from a virtual or simulated contextual menu in order to update the information for the user, so that other users with similar eyewear devices may see the updated information about the user.

### Near Eye Display System (NED) Overview

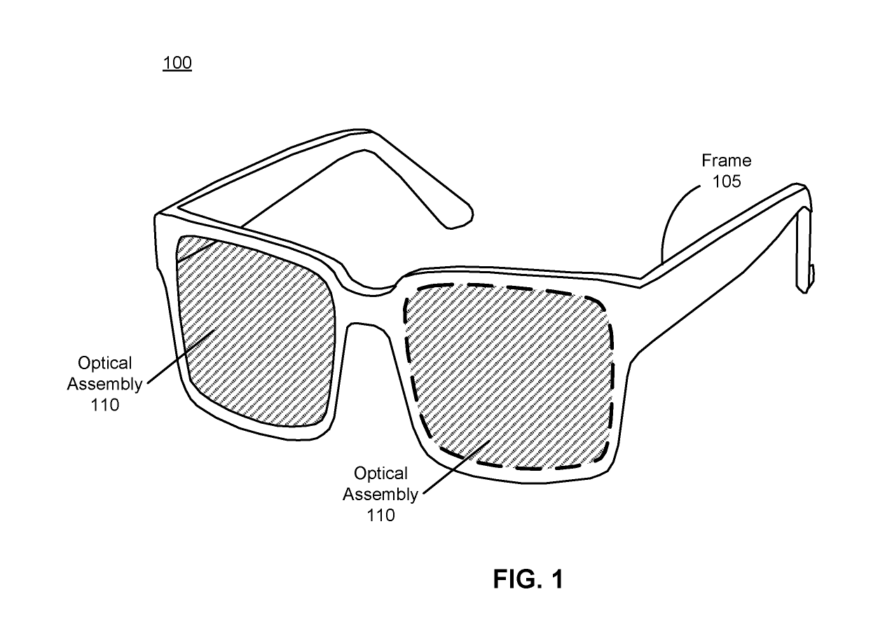

FIG. 1 is a diagram of an eyewear device 100, in accordance with an embodiment. In some embodiments, the eyewear device 100 is a near eye display (NED) for presenting media to a user. Examples of media presented by the eyewear device 100 include one or more images, text, video, audio, or some combination thereof. In some embodiments, audio is presented via an external device (e.g., speakers and/or headphones) that receives audio information from the eyewear device 100, a console (not shown), or both, and presents audio data based on the audio information. The eyewear device 100 can be configured to operate as an artificial reality NED. In some embodiments, the eyewear device 100 may augment views of a physical, real-world environment with computer-generated elements (e.g., images, video, sound, etc.).

The eyewear device 100 shown in FIG. 1 includes a frame 105 and an optical assembly 110, which is surrounded by a rim 115. The optical element 110 is substantially transparent (e.g., allows a percentage transmittance) in the visible spectrum and may also include a substantially transparent electronic display. The frame 105 is coupled to one or more optical elements. In some embodiments, the frame 105 may represent a frame of eye-wear glasses. The optical assembly 110 may be configured for users to see content presented by the eyewear device 100. For example, the eyewear device 110 can include at least one waveguide display assembly (not shown) for directing one or more image light to an eye of the user. A waveguide display assembly includes, e.g., a waveguide display, a stacked waveguide display, a stacked waveguide and powered optical elements, a varifocal waveguide display, or some combination thereof. For example, the waveguide display may be monochromatic and include a single waveguide. In some embodiments, the waveguide display may be polychromatic and include a single waveguide. In yet other embodiments, the waveguide display is polychromatic and includes a stacked array of monochromatic waveguides that are each associated with a different band of light, i.e., are each sources are of different colors. A varifocal waveguide display is a display that can adjust a focal position of image light emitted from the waveguide display. In some embodiments, a waveguide display assembly may include a combination of one or more monochromatic waveguide displays (i.e., a monochromatic waveguide display or a stacked, polychromatic waveguide display) and a varifocal waveguide display. Waveguide displays are described in detail in U.S. patent application Ser. No. 15/495,373, incorporated herein by references in its entirety.

In some embodiments, the optical assembly 110 may include one or more lenses or other layers, such as lenses for filtering ultraviolet light (i.e., sunglass lenses), polarizing lenses, corrective or prescription lenses, safety lenses, 3D lenses, tinted lenses (e.g., yellow tinted glasses), reciprocal focal-plane lenses, or clear lenses that do not alter a user's view. The optical assembly 110 may include one or more additional layers or coatings, such as protective coatings, or coatings for providing any of the aforementioned lens functions. In some embodiments, the optical assembly 110 may include a combination of one or more waveguide display assemblies, one or more lenses, and/or one or more other layers or coatings.

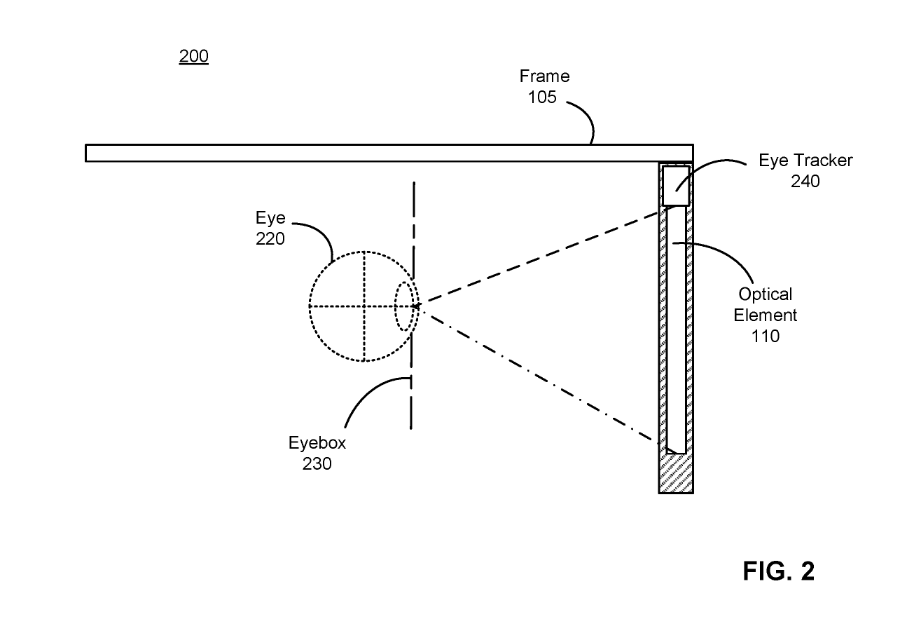

FIG. 2 is a cross-section 200 of the eyewear device 100 illustrated in FIG. 1, in accordance with an embodiment. The optical assembly 110 is housed in the frame 105, which is shaded in the section surrounding the optical assembly 110. A user's eye 220 is shown, with dotted lines leading out of the pupil of the eye 220 and extending outward to show the eye's field of vision. An eyebox 230 shows a location where the eye 220 is positioned if the user wears the eyewear device 100. The eyewear device 100 includes an eye tracking system.

The eye tracking system determines eye tracking information for the user's eye 220. The determined eye tracking information may include information about a position of the user's eye 220 in an eyebox 230, e.g., information about an angle of an eye-gaze. An eyebox represents a three-dimensional volume at an output of a display in which the user's eye is located to receive image light.

In one embodiment, the eye tracking system includes one or more light sources to illuminate the eye at a particular wavelength or within a particular band of wavelengths (e.g., infrared). The light sources may be placed on the frame 105 such that the illumination from the light sources are directed to the user's eye (e.g., the location of the eyebox 230). The light sources may be any device capable of producing visible or infrared light, such as a light emitting diode. The illumination of the user's eye by the light sources may assist the eye tracker 240 in capturing images of the user's eye with more detail. The eye tracker 240 receives light that is emitted from the light sources and reflected off of the eye 220. The eye tracker 240 captures images of the user's eye, and the eye tracker 240 or an external controller can analyze the captured images to measure a point of gaze of the user (i.e., an eye position), motion of the eye 220 of the user (i.e., eye movement), or both. The eye tracker 240 may be a camera or other imaging device (e.g., a digital camera) located on the frame 105 at a position that is capable of capturing an unobstructed image of the user's eye 220 (or eyes).

The one embodiment, the eye tracking system determines depth information for the eye 220 based in part on locations of reflections of the light sources. Additional discussion regarding how the eye tracker 240 determines depth information is found in, e.g., U.S. application Ser. No. 15/456,383 and U.S. application Ser. No. 15/335,634, both of which are hereby incorporated by reference. In another embodiment, the eye tracker 240 does not include light sources, but instead captures images of the user's eye 220 without additional illumination.

The eye tracker 240 can be embedded in an upper portion of the frame 105, but may be located at any portion of the frame at which it can capture images of the user's eye. While only one eye tracker 240 is shown in FIG. 2, the eyewear device 100 may include multiple eye trackers 240 per eye 220.

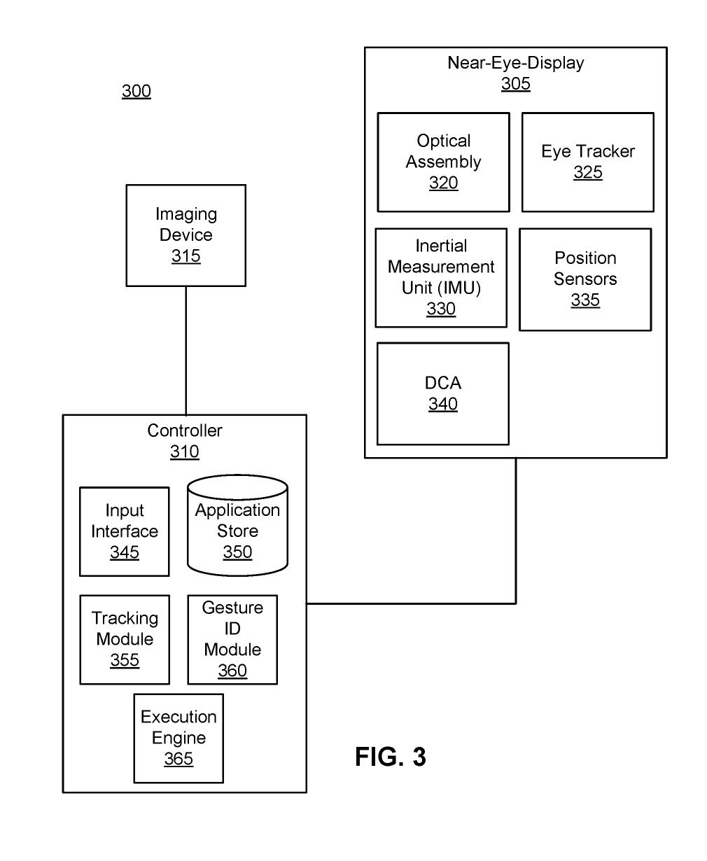

FIG. 3 is a block diagram of a NED system 300 with an eye tracker, in accordance with an embodiment. The NED system 300 shown by FIG. 3 comprises a NED 305 coupled to a controller 310, with the controller 310 coupled to an imaging device 315 imaging device 315. While FIG. 3 shows an example NED system 300 including one NED 305 and one imaging device 315, in other embodiments any number of these components may be included in the NED system 300. In alternative configurations, different and/or additional components may be included in the NED system 300. Similarly, functionality of one or more of the components can be distributed among the components in a different manner than is described here. For example, some or all of the functionality of the controller 310 may be contained within the NED 305. The NED system 300 may operate in an artificial reality environment.

The NED 305 presents content to a user. In some embodiments, the NED 305 is the eyewear device 100. Examples of content presented by the NED 305 include one or more images, video, audio, text, or some combination thereof. In some embodiments, audio is presented via an external device (e.g., speakers and/or headphones) that receives audio information from the NED 305, the controller 310, or both, and presents audio data based on the audio information. In some embodiments, the NED 305 operates as an artificial reality NED. In some embodiments, the NED 305 may augment views of a physical, real-world environment with computer-generated elements (e.g., images, video, sound, etc.).

The NED 305 includes an optical assembly 320 for each eye, an eye tracker 325, an inertial measurement unit (IMU) 330, one or more position sensors 335, and a depth camera array (DCA) 340. Some embodiments of the NED 305 have different components than those described here. Similarly, the functions can be distributed among other components in the NED system 300 in a different manner than is described here. In some embodiments, the optical assembly 320 displays images to the user in accordance with data received from the controller 310. In one embodiment, the optical assembly 320 is substantially transparent (e.g., by a degree of transmittance) to electromagnetic radiation in the visible spectrum.

The eye tracker 325 tracks a user's eye movement. The eye tracker 325 includes a camera for capturing images of the user's eye. An example of the placement of the eye tracker is shown in eye tracker 240 as described with respect to FIG. 2. Based on the detected eye movement, the eye tracker 325 may communicate with the controller 310 for further processing.

In some embodiments, the eye tracker 325 allows a user to interact with content presented to the user by the controller 310 based on the detected eye movement. Example interactions by the user with presented content include: selecting a portion of content presented by the controller 310 (e.g., selecting an object presented to the user), movement of a cursor or a pointer presented by the controller 310, navigating through content presented by the controller 310, presenting content to the user based on a gaze location of the user, or any other suitable interaction with content presented to the user.

In some embodiments, NED 305, alone or conjunction with the controller 310 or another device, can be configured to utilize the eye tracking information obtained from the eye tracker 325 for a variety of display and interaction applications. The various applications include, but are not limited to, providing user interfaces (e.g., gaze-based selection), attention estimation (e.g., for user safety), gaze-contingent display modes, metric scaling for depth and parallax correction, etc. In some embodiments, based on information about position and orientation of the user's eye received from the eye tracking unit, a controller (e.g., the controller 310) determines resolution of the content provided to the NED 305 for presentation to the user on the optical assembly 320. The optical assembly 320 may provide the content in a foveal region of the user's gaze (and may provide it at a higher quality or resolution at this region).

In another embodiment, the eye tracking information obtained from the eye tracker 325 may be used to determine the location of the user's gaze in the local area. This may be used in conjunction with a gesture detection system to allow the system to detect various combinations of user gesture and gazes. As described in further detail below, different combinations of user gaze and gestures, upon detection by the controller 310, may cause the controller 310 to transmit further instructions to devices or other objects in the local area, or execute additional instructions in response to these different combinations.

In some embodiments, the eye tracker 325 includes a light source that is used to project light onto a user's eye or a portion of the user's eye. The light source is a source of the light that is reflected off of the eye and captured by the eye tracker 325.

The IMU 330 is an electronic device that generates IMU tracking data based on measurement signals received from one or more of the position sensors 335. A position sensor 325 generates one or more measurement signals in response to motion of the NED 305. Examples of position sensors 335 include: one or more accelerometers, one or more gyroscopes, one or more magnetometers, another suitable type of sensor that detects motion, a type of sensor used for error correction of the IMU 330, or some combination thereof. The position sensors 335 may be located external to the IMU 330, internal to the IMU 330, or some combination thereof.

Based on the one or more measurement signals from one or more position sensors 335, the IMU 330 generates IMU tracking data indicating an estimated position of the NED 305 relative to an initial position of the NED 305. For example, the position sensors 335 include multiple accelerometers to measure translational motion (forward/back, up/down, left/right) and multiple gyroscopes to measure rotational motion (e.g., pitch, yaw, and roll). In some embodiments, the IMU 330 rapidly samples the measurement signals and calculates the estimated position of the NED 305 from the sampled data. For example, the IMU 330 integrates the measurement signals received from the accelerometers over time to estimate a velocity vector and integrates the velocity vector over time to determine an estimated position of a reference point on the NED 305. Alternatively, the IMU 330 provides the sampled measurement signals to the controller 310, which determines the IMU tracking data. The reference point is a point that may be used to describe the position of the NED 305. While the reference point may generally be defined as a point in space; however, in practice the reference point is defined as a point within the NED 305 (e.g., a center of the IMU 330).

The depth camera array (DCA) 340 captures data describing depth information of a local area surrounding some or all of the NED 305. The DCA 340 can compute the depth information using the data (e.g., based on a captured portion of a structured light pattern), or the DCA 340 can send this information to another device such as the controller 710 that can determine the depth information using the data from the DCA 340.

The DCA 340 includes a light generator, an imaging device and a controller. The light generator of the DCA 340 is configured to illuminate the local area with illumination light in accordance with emission instructions. The imaging device of the DCA 340 includes a lens assembly, a filtering element and a detector. The lens assembly is configured to receive light from a local area surrounding the imaging device and to direct at least a portion of the received light to the detector. The filtering element may be placed in the imaging device within the lens assembly such that light is incident at a surface of the filtering element within a range of angles, wherein the range of angles is determined by a design range of angles at which the filtering element is designed to filter light. The detector is configured to capture one or more images of the local area including the filtered light. In some embodiments, the lens assembly generates collimated light using the received light, the collimated light composed of light rays substantially parallel to an optical axis. The surface of the filtering element is perpendicular to the optical axis, and the collimated light is incident on the surface of the filtering element. The filtering element may be configured to reduce an intensity of a portion of the collimated light to generate the filtered light. The controller of the DCA 340 generates the emission instructions and provides the emission instructions to the light generator. The controller of the DCA 340 further determines depth information for the one or more objects based in part on the captured one or more images.

The imaging device 315 may be used to capture a representation of the user's hands over time for use in tracking the user's hands (e.g., by capturing multiple images per second of the user's hand). To achieve a more accurate capture, the imaging device 315 may be able to capture depth data of the local area or environment. This may be achieved by various means, such as by the use of computer vision algorithms that generate 3D data via detection of movement in the scene, by the emission of a grid pattern (e.g., via emission of an infrared laser grid) and detection of depth from the variations in the reflection from the grid pattern, from computation of time-of-flight of reflected radiation (e.g., emitted infrared radiation that is reflected), and/or from the user of multiple cameras (e.g., binocular vision/stereophotogrammetry). The imaging device 315 may be positioned to capture a large spatial area, such that all hand movements within the spatial area are captured. In one embodiment, more than one imaging device 315 is used to capture the user's hands.

In another embodiment, the imaging device 315 may also capture images of one or more objects in the local area, and in particular the area encompassing the field of view of a user wearing an eyewear device that includes the NED 305. The imaging device 315 may also capture depth data of these one or more objects in the local area according to any of the methods described above.

Although the imaging device 315 is illustrated in FIG. 3 as being separate from the NED 305, in some embodiments the imaging device is attached to the NED 305, e.g., attached to the frame 105.

The imaging device 315 may include one or more cameras, imaging sensor, one or more video cameras, any other device capable of capturing images, or some combination thereof. Additionally, the imaging device 315 may include one or more hardware and software filters (e.g., used to increase signal to noise ratio). Image tracking data is communicated from the imaging device 315 to the controller 310, and the imaging device 315 receives one or more calibration parameters from the controller 310 to adjust one or more imaging parameters (e.g., focal length, focus, frame rate, ISO, sensor temperature, shutter speed, aperture, etc.).

The controller 310 provides content to the NED 305 for presentation to the user in accordance with information received from the imaging device 315 or the NED 305. In the example shown in FIG. 3, the controller 310 includes an input interface 345, an application store 350, a tracking module 355, a gesture ID module 360, and an execution engine 365. Some embodiments of the controller 310 have different modules than those described herein. Similarly, the functions further described below may be distributed among components of the controller 310 in a different manner than is described herein. In one embodiment, the controller 310 is a component within the NED 305.

In one embodiment, the controller 310 includes an input interface 345 to receive additional external input. These external inputs may be action requests. An action request is a request to perform a particular action. For example, an action request may be to start or end an application or to perform a particular action within the application. The input interface 345 may receive input from one or more input devices. Example input devices include: a keyboard, a mouse, a game controller, or any other suitable device for receiving action requests. In another embodiment, the input interface 345 receives input from one or more radio frequency (RF) signal receivers. These may be used to receive radio signals from RF identifiers in the local area, and in some cases to determine a distance (based on signal strength) and position (based on triangulation or other method) of the RF identifier. After receiving an action request, the controller 310 performs an action corresponding to the action request. In some embodiments, the action performed by the controller 310 may include haptic feedback, which may be transmitted via the input interface 345 to haptic feedback devices.

The application store 350 stores one or more applications for execution by the controller 310. An application is a group of instructions, that when executed by a processor, generates content for presentation to the user. Content generated by an application may be in response to inputs received from the user via movement of the NED 305, the input interface 345, or the eye tracker 325. Examples of applications include: gaming applications, conferencing applications, video playback application, or other suitable applications.

The tracking module 355 tracks movements of the NED 305 and the hands of the user wearing the NED 305. To track the movement of the NED 305, the tracking module 355 uses information from the DCA 340, the one or more position sensors 335, the IMU 330 or some combination thereof. For example, the tracking module 355 determines a position of a reference point of the NED 305 in a mapping of a local area based on information from the NED 305. The tracking module 355 may also determine positions of the reference point of the NED 305 using data indicating a position of the NED 305 from the IMU 330. Additionally, in some embodiments, the tracking module 355 may use portions of data indicating a position or the NED 305 from the IMU 330 as well as representations of the local area from the DCA 340 to predict a future location of the NED 305. The tracking module 355 may provide the estimated or predicted future position of the NED 305 to the execution engine 365.

As noted, the tracking module 355 also tracks the user's hands, and the digits of the user's hands, in order to recognize various poses for the user's hand. Each pose indicates a position of a user's hand. By detecting a combination of multiple poses over time, the tracking module 355 is able to determine a gesture for the user's hand. These gestures may in turn translate into various inputs to the system. For example, a movement using a single digit in one direction may translate into a button press input in the system.

In one embodiment, the tracking module 355 uses a deep learning model to determine the poses of the user's hands. The deep learning model may be a neural network, such as a convolutional neural network, or a residual neural network. The neural network may take as input feature data extracted from raw data from the imaging device 315 of the hand, e.g., depth information of the user's hand, or data regarding the location of locators on any input device worn on the user's hands. The neural network may output the most likely pose that the user's hands are in. Alternatively, the neural network may output an indication of the most likely positions of the joints of the user's hands. The joints are positions of the user's hand, and may correspond to the actual physical joints in the user's hand, as well as other points on the user's hand that may be needed to sufficiently reproduce the motion of the user's hand in a simulation.

If the neural network outputs the positions of joints, the tracking module 355 additionally converts the joint data into a pose, e.g., using inverse kinematics principles. For example, the position of various joints of a user's hand, along with the natural and known restrictions (e.g., angular, length, etc.) of joint and bone positions of the user's hand allow the tracking module 355 to use inverse kinematics to determine a most likely pose of the user's hand based on the joint information. The pose data may also include an approximate structure of the user's hand, e.g., in the form of a skeleton, point mesh, or other format.

The neural network is trained using training data. In one embodiment, the training data is generated from a multiple camera array, such as multiple imaging devices 315, that captures hand movements in different poses with different hands from different users, and/or the locators on input devices worn by the different hands. The ground truth for this training data indicates joint positions and/or poses for the hands, and may be generated using human verification.

The gesture ID module 360 identifies the gestures of a user's hand based on the poses determined by the tracking module 355. The gesture ID module 360 may utilize a neural network to determine a gesture from a particular series of poses. Such a neural network may be trained using as input data computed poses (or joints) and with output data indicating the most likely gesture. Other methods may be used by the gesture ID module 360 to determine the gesture from the pose, such as a measurement of the distances and positions between the digits of the hand and the positions of a series of poses in 3D space. If these distances and positions of each pose fall within certain thresholds, the gesture ID module 360 may indicate that a particular gesture is present.

Using such a method, the tracking module 355 is able to determine the likely poses of a user's hands, and with the determination of the poses, the gesture ID module 360 may be able to match the movement of the user's hands with predefined gestures. These gestures may be used to indicate various actions in an augmented reality environment.

Additional details regarding the tracking and determination of hand positions using imaging devices and input devices are described in U.S. application Ser. No. 15/288,453, filed Oct. 7, 2016, and U.S. App. No. 62/401,090, filed Sep. 28, 2016, both of which are incorporated by reference in their entirety.

In another embodiment, the tracking module 355 is also configured to recognize objects in images captured by the imaging device 315. To perform this function, the tracking module 355 may first be trained on a large corpus of labeled object data, or be coupled to a pre-trained image recognition system, which may be on an online system. In the former case, the tracking module 355 includes a machine learning model (e.g., a convolutional neural network) and is trained on a standard image-object library (e.g., ImageNet), or on a large set of user-provided images from an online system. These user-provided images may include a large number of images of objects, as well as a labeling of these objects (e.g., using captions, etc.). Alternatively, in the latter case, the online system itself already includes a machine learning model trained on the aforementioned user-provided and labeled images. For example, the online system may already have an object recognition system which receives images and outputs a label for each. The model on the online system is used instead of any model on the controller 310 to perform the object recognition in this case. After recognizing an object, the tracking module 355 may be able to track the location of the object in the field of view provided by the NED 305 to the user. This may be achieved by continuously recognizing users in each frame captured by the imaging device 315. Once an object is recognized, the tracking module 355 can indicate the location of the object, and the boundaries of the object (e.g., the pixels corresponding to the recognized object) in the captured image. This can be translated to a location of the object in the user's field of view provided by the NED 305 through the optical assembly 310.

In one embodiment, the controller 310 additionally includes an execution engine 365. The execution engine 365 executes applications within the NED system 300 and receives position information, acceleration information, velocity information, predicted future positions, or some combination thereof, from the NED 305, input interface 345, and/or the tracking module 355. Based on the received information, the execution engine 365 determines content to provide to the NED 305 for presentation/display to the user. For example, if the received information indicates that the user has looked to the left, the execution engine 365 generates content for the NED 305 that is based off the user's movement in the artificial reality environment. Similarly, if information received from the tracking module 355 indicates the user's hand makes a particular gesture, the execution engine 365 generates content based on the identified gesture. In addition, if the information received from the NED 305 indicates a particular gaze of the user, the execution engine 365 may generate content based on that gaze. This content may include an update to the optical assembly 320 in the NED 305, such that content displayed to a user wearing the NED 305 changes.

The execution engine 365 may also perform an action within an application executing on the controller 310 in response to an action request received from the input interface 345 and provides feedback to the user that the action was performed. The provided feedback may be visual or audible feedback via the NED 305. For example, the execution engine 365 may receive an action from the input interface 345 to open an application, and in response, the execution engine 365 opens the application and presents content from the application to the user via the NED 305.

In addition to determining the current pose of the user's hand(s), the execution engine 365 may also provide output to the optical assembly 320 in accordance with a set of display instructions (e.g., pixel data, vector data, etc.). This output to the electronic display of the optical assembly 320 may include a virtual recreation (using computer graphics) of the user's hands, as well as other objects (virtual or otherwise), such as outlines of objects in the local area, text, graphics, other elements that coincide with objects within a field of view of a user wearing the NED 305, and so on.

The execution engine 365 may receive from the tracking module 355 an indication of a tracked object. Such an object may have previously been selected by the user via the input interface 345 to be enhanced. Upon receiving the indication of the tracked object, the execution engine 365 transmits display instructions to the optical assembly 320 to cause the optical assembly 320 to display various elements, such as contextual menus, informational menus, and so on, to the user. These displayed elements may be shown at a threshold distance from the tracked object as viewed by the user in the augmented or artificial reality environment presented by the NED 305.

In one embodiment, the execution engine 365 may first recognize the recognizable objects in a local area as captured by the imaging device 315. An object is recognized if it is first identified by a user. To do this, the user may activate via a gesture or other action to identify an object (e.g., a non-virtual object) in the local area to enhance. This gesture can be a touch gesture with the object, which is recognized by the gesture ID module 360 when one of the user's fingers is within a threshold distance of the object that is in the local area. If that object was previously recognized by the execution engine 365, the execution engine 365 can store a recognition pattern of the object. A recognition pattern may include a unique identifier of the object as generated by the object recognition system of the tracking module 355. The recognition pattern may include the values of the output parameters generated by the object recognition system that caused the tracking module 355 to recognize the object (e.g., the confidence weights generated by the object recognition system). In another embodiment, the recognition pattern may be some other fingerprint, pattern, identifier, or other data that is able to be used to recognize the object again under different orientation and lighting. When the object is encountered again, the object recognition system of the tracking module 355 may generate another identifier based on the characteristics of the object. This identifier is compared to the stored recognition pattern for the object, and if a match occurs, the object is recognized as the object associated with the stored recognition pattern.

In one embodiment, the execution engine 365, upon receiving the request to enhance an object, transmits display instructions to the optical assembly 320 to display a prompt to the user. The prompt requests the user to enter an object capture mode whereby the user is asked to place the object in front of the imaging device 315 of the NED and to rotate it along different axes in order for the execution engine 365 to generate a model of the object. This model may comprise a three dimensional representation of the object (e.g., using a point mesh, polygonal data, etc.). This model may also be used as a recognition pattern for the object. In another embodiment, the various captured images of the object are provided as training data into a machine learning model that is used to recognize the object. These images serve as a recognition pattern for the machine learning model, and the model can subsequently be used to recognize the object again.

Additionally, in some embodiments, the execution engine 365 further utilizes additional tracking indicators in the local area to assist in the recognition of enhanced objects. As noted above, the objects in the environment may have RF identifiers, which may be received by the input interface 345 via one or more RF receivers. The execution engine 365, via the signals received from the RF receivers, and through various signal source locating mechanisms (e.g., triangulation, time-of-flight, Doppler shift), may determine the position of an object that has an RF identifier using the RF signals from the object. This information may be used to augment (e.g., adjust for error) the image based object recognition system, or may be used in place of the image based object recognition system (e.g., in the case where the image based object recognition system fails or has high error/uncertainty). Other tracking indicators, such as retroreflectors (which may respond to a non-visible light signal from the eyewear device 100), high contrast locators, QR codes, barcodes, identifying image patterns, and so on, may also be used by the execution engine 365 to assist in recognizing the object, and this information may be stored in the recognition pattern for the object.

After setting an object to be enhanced, the execution engine 365 may subsequently recognize the enhanced object in images captured by the imaging device 315 (and/or via the other tracking mechanisms described) by using the recognition pattern(s) generated for that enhanced object. Upon recognition of the enhanced object, the execution engine 365 may update the display instructions of the optical assembly 320 to present additional simulated or virtual elements related to the enhanced object in the augmented reality environment presented by the NED. The virtual elements may be positioned in the augmented reality environment at a threshold distance (e.g., 1 cm) of the enhanced object. The execution engine 365 may compute the position of the enhanced object in 3D space and project the virtual elements on the display such that they appear to be within the 3D space and near to the enhanced object (within the threshold distance). Upon detection of movement of the enhanced object, the execution engine 365 may submit updated display instructions to move the virtual elements based on the movement of the enhanced object.

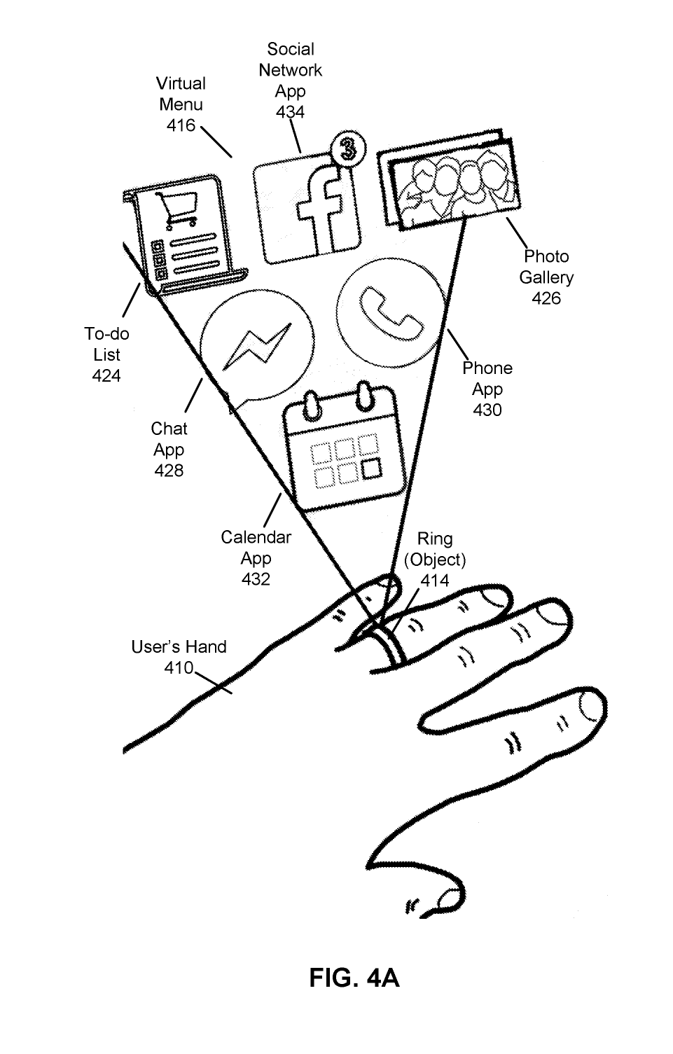

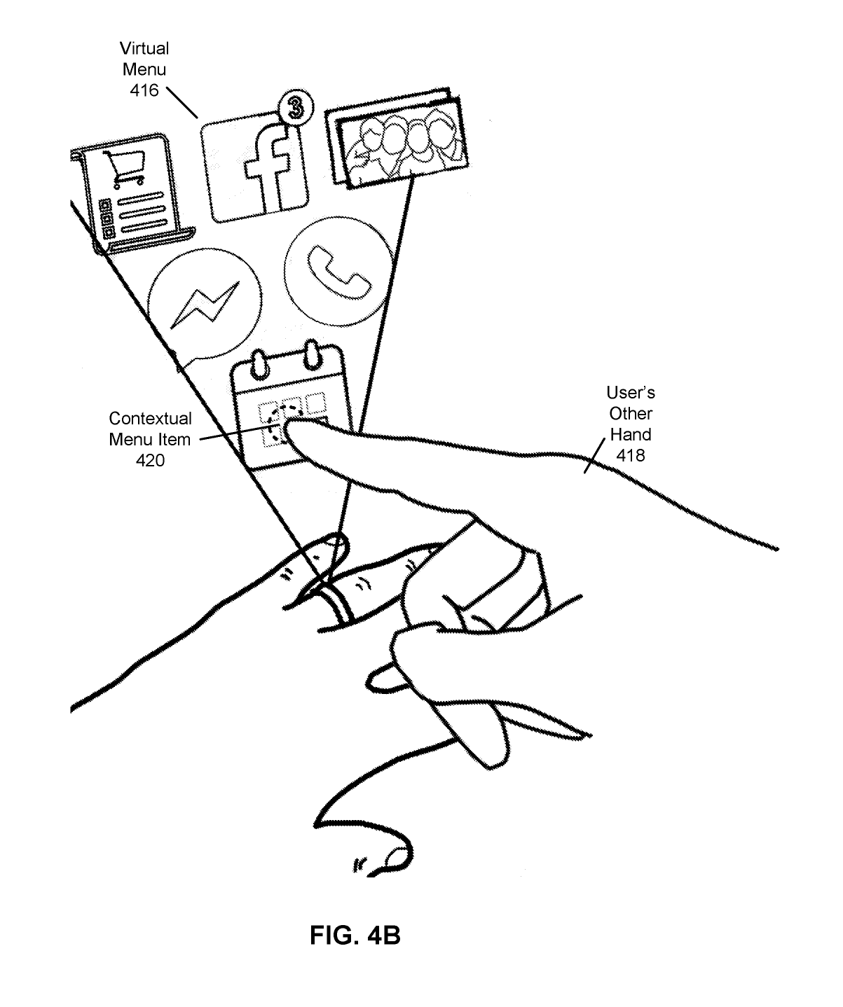

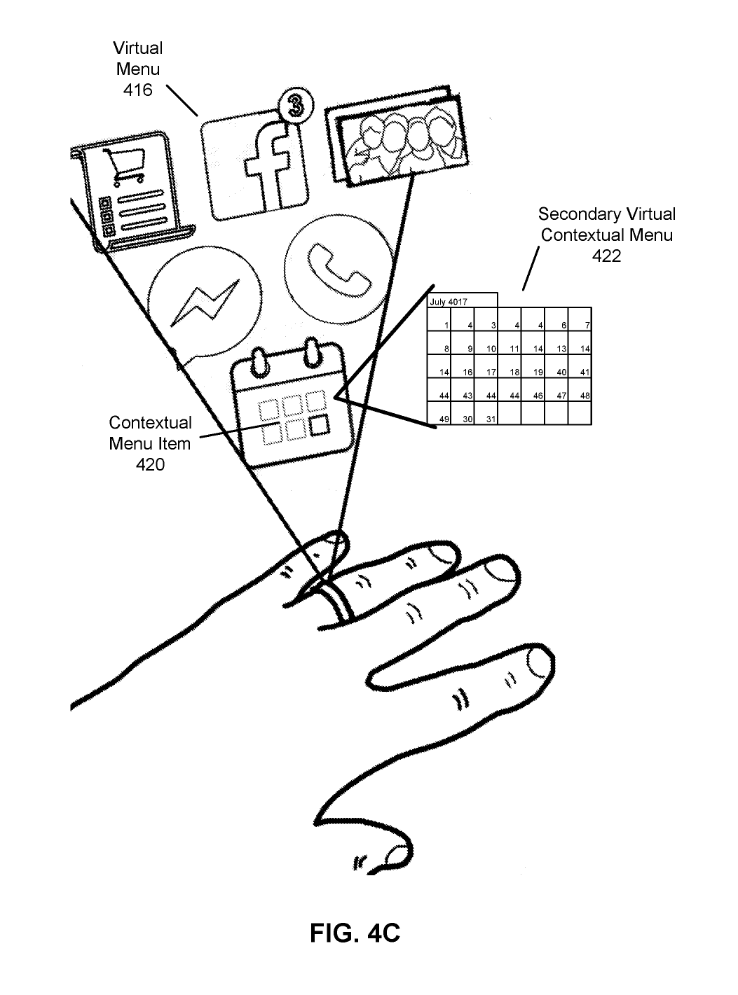

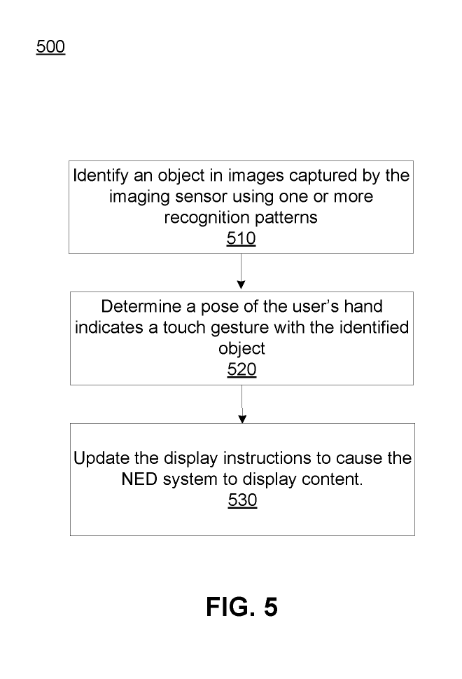

The related virtual elements that are presented upon detection of the enhanced object may be presented only after an activation gesture, such as the touch gesture described earlier. Alternatively, the virtual elements are presented automatically upon detection of the enhanced object. The virtual elements that are presented are selected in relation to the enhanced object. They may be separately selected by the user (via a graphical interface) or determined automatically by the execution engine 365 based on the type of enhanced object. The object recognition system utilized by the execution engine 365 may recognize the type of a recognized object. The execution engine 365 may further include a database of object-virtual element associations that is used to select specific virtual elements to be presented upon recognizing a specific object type. Additional details regarding this object enhancement are described below with reference to FIGS. 4A-5.

### Object Enhancement

The following figures illustrate a NED system (e.g., system 300) having object recognition and gesture tracking capabilities that allow a NED (e.g., NED 305) to enhance an object in the local area such that interaction by the user (using various gestures) causes a controller (e.g., controller 310) of the NED system to update the NED of the NED system to display various interactive and/or informational elements to the user.

FIG. 4A illustrates an exemplary NED display filter applied to a NED for enhancing a physical object with virtual elements, according to an embodiment. The perspective in FIG. 4A is that of a user viewing the local area through the NED 305. In the illustrated example, the enhanced object is a ring 414 on a user's hand 410, and the controller 310 presents a virtual menu 416 (by updating the display instructions) in response to recognizing the ring. The virtual menu 416 may be selected because the controller 310 is configured to present a menu of personal organizer type virtual menu options when the enhanced object is a ring. The menu options in the virtual menu 416 include a to-do list 424, photo gallery 426, chat application 428, phone application 430, calendar application 432, social network application 434, and so on. However, in other embodiments, different options may be shown in the virtual menu 416.

FIG. 4B illustrates an exemplary NED display filter applied to the NED of FIG. 4A for providing a virtual menu upon interaction with an enhanced object, according to an embodiment. The scene illustrated in FIG. 4B continues from the scene in FIG. 4A.

In the illustrated scene of FIG. 4B, the controller 310 detects a touch gesture of the user's other hand 418 with one of the contextual menu items in the virtual menu 416 that is associated with the ring 414. The touch gesture with an element is detected when the user's hand forms a series of poses where the user's finger moves within a threshold distance with an element. In another embodiment, the controller 310 detects a pinch gesture with one of the contextual menu items in the virtual menu 416. The pinch gesture is detected when the distal portions of the user's index finger and thumb are within a threshold distance of each other, and a point between the distal ends of the user's index finger and thumb are within a threshold distance of the element. Here, the element is a contextual menu item 420 of the virtual menu 416, a calendar icon. In response, the controller 310 may provide updated display instructions that cause the NED to present to the user an indication of the selection of the contextual menu item 420. This may be represented by a change in color, a highlight, a movement of the selected contextual menu item, and so on.

FIG. 4C illustrates an exemplary NED display filter applied to the NED of FIG. 4B for providing a secondary virtual contextual menu upon interaction with a virtual menu of an enhanced object, according to an embodiment. The scene illustrated in FIG. 4C continues from the scene in FIG. 4B.

In the illustrated scene of FIG. 4C, the controller 310 has previously detected a touch gesture (or pinch gesture) with the contextual menu item 420 (a calendar icon). Although the calendar icon is selected in the illustrated example, in other cases any of the other icons in the virtual menu 416 could be selected (from detection of a touch or pinch gesture with that icon in the virtual menu 416).

After detecting the interaction with the contextual menu icon 420, the controller 310 sends additional display instructions to the optical assembly 110 to display a secondary virtual contextual menu 422. This secondary virtual contextual menu may be related to the selected contextual menu option 420, and may be displayed at a set or threshold distance from the contextual menu option 420 that is selected using the previous touch or pinch gesture. For example, here the secondary virtual contextual menu 422 is a calendar displaying the current month. The calendar may display appointments, have options to set appointments, and have other features and standard functions related to calendar applications. If the contextual menu option 420 were some other application or option, the secondary virtual contextual menu 422 might be different as a result. The controller 310 may further detect a touch or pinch gesture with one of the options in the secondary virtual contextual menu 422, and execute some action in relation to the detection of the touch or pinch gesture.

In some embodiments, the controller 310, via a wireless interface of the NED system 300, can transmit signals to the enhanced object, which also includes a wireless interface. The controller 310 may transmit instructions to allow a level of interactivity or feedback at the enhanced object in response to actions by the user against the virtual elements associated with the enhanced object. For example, the enhanced object may include haptic feedback, visual feedback, and/or audio feedback mechanisms (e.g., a linear actuator, display or light, speaker, etc.) that allow the controller 310 to send instructions to these feedback mechanisms in response to the user performing certain gestures with the virtual elements associated with the enhanced object. For example, the controller 310 may send a message to the enhanced object to cause the enhanced object to vibrate via a haptic feedback mechanism when the controller 310 detects a touch or pinch gesture with the contextual menu option of a virtual menu associated with the enhanced object. As another example, the feedback could be audio feedback that is configured to sound as if it is coming from the enhanced object.

In one embodiment, the controller 310 receives a de-enhancement request for an object from the user. This may be performed via an interaction with a virtual menu associated with the object, or via a detected gesture against the object performed by the user. In response to such a request, the controller 310 disables the enhanced features for the object, i.e., the presentation of the virtual menu with the object, and may also remove the recognition pattern for the object.

Although the above examples are shown with a virtual menu 416 and other virtual menus in mid-air, in other embodiments the virtual menu 416 may appear in the AR environment to be on the surface of an object in the local area. This object may in some cases be the enhanced object itself, if the enhanced object has a large enough surface to accommodate the area of the virtual menu 416. The controller 310 may determine whether to present the virtual menu 416 in mid-air or on an object based on a setting indicated by the user. Alternatively, the controller 310 may determine whether a surface on the enhanced object is large enough to place the virtual menu 416 on the surface, and if so, the controller 310 places the virtual menu 416 on the surface. The user may then interact with the virtual menu 416 as described above.

### Exemplary Flow

FIG. 5 is a flowchart illustrating a method for providing object enhancement in a NED, according to an embodiment. In one embodiment, the steps in the flowchart may be performed by the controller 310. In another embodiment, the steps may be performed by another component as described in the system 300. Although a particular order is implied by the flowchart, in other embodiments the steps in the flowchart may be performed in a different order.

The controller 310 identifies 510 an object in images captured by the imaging sensor using one or more recognition patterns. For example, the controller 610 may use captured images of a local area from an imaging device (e.g., imaging device 315). Using an object recognition system, such as one provided by an online system, the controller 310 recognizes objects in the captured images which match a previously generated recognition pattern.

The controller 310 determines 520 a pose of the user's hand indicates a touch gesture with the identified object. The touch gesture is formed by a movement of the user's index finger in a direction towards the identified object such that the distance between the user's index finger and the position of the object is within a threshold value.

The controller 310 updates 530 the display instructions to cause the NED system 300 to display content, such as the virtual menu 416 described in FIGS. 4A-C. The display instructions may further instruct the display to present the virtual menu within a threshold distance of the position of the object in the augmented reality environment. An example of a virtual menu may include icons and text indicating various options customized for the user, such a calendar, contacts, and so on.

### Additional Configuration Information

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. For example, in some embodiments, the sensor module 142 may include designed hardware for imaging and image processing that computes optical flow information. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

What is claimed is:

1. A system comprising:
a near eye display (NED) that is configured to display images in accordance with display instructions;
an imaging sensor configured to capture images, the images including at least one image of an object and at least one image of a user's hands; and
a controller configured to:
identify the object in the captured images using one or more recognition patterns;
determine a pose of the user's hand based on the captured images, the determined pose indicating a touch gesture with the identified object, the touch gesture formed by a movement of the user's index finger in a direction towards the identified object such that the distance between the user's index finger and the position of the object is within a threshold value; and
update the display instructions to cause the electronic display to display a virtual menu in an artificial reality environment, the virtual menu within a threshold distance of the position of the object in the artificial reality environment.

2. The system of claim 1, wherein the controller is further configured to:
determine that the pose of the user's hand indicates the touch gesture with one of the contextual menu options of the virtual menu;
execute instructions corresponding to the one of the contextual menu options; and
update the display instructions to cause the electronic display to display an indication of the activation of the one of the contextual menu options.

3. The system of claim 2, wherein the indication of the activation of the one of the contextual menu options comprises a secondary contextual menu corresponding to the one of the contextual menu options.

4. The system of claim 1, wherein the controller is further configured to:
receive additional captured images from the imaging sensor;
detect the object in the additionally captured images based on the one or more recognition patterns;
determine a movement of the object in the additionally captured images relative to the position of the object in previously captured images;
determine a new position of the object based on the determined movement; and
update the display instructions to cause the substantially transparent electronic display to display the virtual menu in a new position that is within a threshold distance of the new position of the object in the augmented reality environment.

5. The system of claim 1, wherein the object is a wearable ring.

6. The system of claim 1, wherein a radio frequency (RF) identifier is attached to the object, and wherein the controller is further configured to:
receive from the RF identifier a radio signal including an identifier for the object;
update the one or more recognition patterns to include the identifier; and
determine the position of the object further based on the direction and signal delay of the radio signal.

7. The system of claim 1, wherein a marker is attached to the object, and the controller is further configured to:
detect the marker attached to the object in one or more of the captured images; and
update the one or more recognition patterns to include the marker.

8. The system of claim 1, wherein a marker includes a pattern that encodes identifying information, and wherein the controller is further configured to:
decode an identifier from the pattern included with the marker;
update the one or more recognition patterns to include the identifier; and
determine the position of the object further based on detecting the pattern corresponding to the identifier on the object.

9. The system of claim 1, wherein the object enhancement request comprises the touch gesture made by the user's hand against the object.

10. The system of claim 1, wherein the contextual menu options in the virtual menu are selected by the controller based on the type of the object.

11. The system of claim 1, wherein the controller is further configured to:
receive an object enhancement request for the object;
access one or more images of the object; and
generate the one or more recognition patterns of the object based on the accessed images.

12. A near eye display (NED), comprising:
an electronic display configured to display images in accordance with display instructions;
an imaging sensor configured to capture images, the images including at least one image of an object and at least one image of a user's hands; and
a controller configured to:
identify the object in one or more of the captured images using one or more recognition patterns;
determine a pose of the user's hand based on one or more of the captured images, the determined pose indicating a touch gesture with the identified object, the touch gesture formed by a movement of the user's index finger in a direction towards the identified object such that the distance between the user's index finger and the position of the object is within a threshold value; and
update the display instructions to cause the electronic display to display a virtual menu in an artificial reality environment, the virtual menu within a threshold distance of the position of the object in the artificial reality environment.

13. The NED of claim 12, wherein the controller is further configured to:
determine that the pose of the user's hand indicates the touch gesture with one of the contextual menu options of the virtual menu;
execute instructions corresponding to the one of the contextual menu options; and
update the display instructions to cause the electronic display to display an indication of the activation of the one of the contextual menu options.

14. The NED of claim 12, wherein the indication of the activation of the one of the contextual menu options comprises a secondary contextual menu corresponding to the one of the contextual menu options.

15. The NED of claim 12, wherein the controller is further configured to:
receive captured additional images from the imaging sensor;
detect the object in the additionally captured images based on the one or more recognition patterns;
determine a movement of the object in the additionally captured images relative to the position of the object in previously captured images;
determine a new position of the object based on the determined movement; and
update the display instructions to cause the substantially transparent electronic display to display the virtual menu in a new position that is within a threshold distance of the new position of the object in the augmented reality environment.

16. The NED of claim 12, wherein a radio frequency (RF) identifier is attached to the object, and wherein the controller is further configured to:
receive from the RF identifier a radio signal including an identifier for the object;
update the one or more recognition patterns to include the identifier; and
determine the position of the object further based on the direction and signal delay of the radio signal.

17. The NED of claim 12, wherein a marker is attached to the object, and wherein the controller is further configured to:
detect the marker attached to the object in the captured images; and
update the one or more recognition patterns to include the marker.

18. The NED of claim 12, wherein a marker includes a pattern that encodes identifying information, and wherein the controller is further configured to:
decode an identifier from the pattern included with the marker;
update the one or more recognition patterns to include the identifier; and
determine the position of the object further based on detecting the pattern corresponding to the identifier on the object.

19. The NED of claim 12, wherein the controller is further configured to:
receive an object de-enhancement request for the object, the object de-enhancement request activated from a contextual menu option in the virtual menu.

20. The NED of claim 12, wherein the contextual menu options in the virtual menu are selected by the controller based on the type of the object.
